(19) United States
(12) Patent Application Publication
(10) Pub. No.: US 2020/0026016 A1
(43) Pub. Date: Jan. 23, 2020

(54) HIGH DENSITY, LOW BEND LOSS OPTICAL FIBER RIBBON CABLE

(71) Applicant: CORNING RESEARCH & DEVELOPMENT CORPORATION, Corning, NY (US)

(72) Inventors: Eric Raymond Logan, Hickory, NC (US); Kenneth Darrell Temple, JR., Newton, NC (US)

(21) Appl. No.: 16/377,747

(22) Filed: Apr. 8, 2019

Related U.S. Application Data
(63) Continuation of application No. PCT/US17/62289, filed on Nov. 17, 2017.
(60) Provisional application No. 62/423,431, filed on Nov. 17, 2016.

(51) Int. Cl. G02B 6/44

(52) U.S. Cl. CPC G02B 6/4434

(57) ABSTRACT

A fiber optic cable includes a cable jacket having an inner surface that defines a core, and an optical transmission core element provided in the core that includes an optical fiber group of optical fiber ribbons located within a buffer tube, wherein the optical fiber group comprises a plurality of optical fiber subgroups, each subgroup having one or more sets of 6 fiber base ribbon subunits arranged in substantially planar fashion, each 6 fiber base ribbon subunit comprising six 200 μm optical fibers in a cured ribbon matrix.

### PRIORITY APPLICATIONS

This application is a continuation of International Application No. PCT/US17/062289, filed on Nov. 17, 2017, which claims the benefit of priority to U.S. Provisional Application Ser. No. 62/423,431, filed on Nov. 17, 2016, the content of which is relied upon and incorporated herein by reference in its entirety.

### BACKGROUND

The disclosure relates generally to optical communication cables and more particularly to high fiber count optical communication cables with outside diameters configured to fit into ducts of specified dimensions. High fiber count optical communication cables may be used, for example, in hyper data center applications where the demand for fiber count in a single cable may exceed 3,000 fibers. Yet the need exists to use existing ducts having small inside diameters for routing of these high fiber density cables.

Today's conventional ribbon cables are based on technologies that have changed very little for nearly twenty years. For example, conventional 216 fiber ribbon stacks typically comprise eighteen 12 fiber ribbons. As cable prices have decreased over the years, cable installation costs have continued to increase. Accordingly, there is a desire to put more fibers in the same space in order to reduce total installed costs. The trend is toward smaller diameter cables and/or the most fibers possible that can fit inside a given diameter duct space.

Cable suppliers have been working on higher fiber density cable solutions, resulting in, for example, 2000 fiber cable solutions with cable diameters similar to the 1000 fiber cable solutions of yesteryear. Some such cable solutions rely on rollable ribbon concepts, which incorporate, for example, intermittent webs lightly tacking the fibers together to create flexible ribbons that can be more easily rolled to conform to high density packing in a cable jacket or duct.

However, a key customer value for these cables remains the desire that the fibers can still be mass fusion spliced in units of 12. To enable easier handling for splicing in the field, a high density ribbon stack cable is needed with ribbons that retain at least some of the solid structure of conventional ribbons when compared to the rollable ribbon solutions, for example.

### SUMMARY

Conventional ribbon cables typically comprise stacks of 12 fiber ribbons of 250 μm fibers. In accordance with the desire to achieve higher fiber densities in cables without enlarging the space required to house the higher fiber counts, aspects of the present disclosure may be based on 200 μm low loss optical fibers. This includes a new ribbon stack based on 200 μm low loss optical fiber in a 6 fiber ribbon subunit base structure which achieves better fiber density for a given diameter compared to conventional ribbon cables.

The 6 fiber subunit base structure may be used in 6, 12, 18, 24, 30 and 36 fiber ribbon widths which are subsequently incorporated into cables with high density ribbon stacks. The improved density is further enabled by the use of improved microbend performance fiber. Field mass fusion splicing parameters are disclosed herein that provide acceptable fusion splicing of 200 μm spaced ribbons to conventional previously installed 250 μm spaced fibers. In accordance with yet other aspects of the present disclosure, cable solutions include splitting the wider ribbons into their base 6 fiber subunits, then arranging the two 6 fiber subunits side by side for a 12 fiber mass fusion splice. By separating the two 6 fiber subunits, the 200 μm spaced ribbons may be mass fusion spliced to legacy 250 μm spaced ribbons that may have been previously installed in a legacy network, for example.

### BRIEF DESCRIPTION OF THE DRAWINGS

FIG. 1 is an isometric view of a fiber optic cable in accordance with aspects of the present disclosure.

FIG. 2 is a cross sectional view of the cable of FIG. 1 taken at line 2-2.

FIG. 3 is a cross sectional view comparison of a conventional 250 μm 24 fiber optic ribbon cable to a 200 μm 24 fiber optic cable using 6 fiber base ribbon units, in accordance with aspects of the present disclosure.

FIG. 4 is a cross sectional view comparison of a conventional 250 μm 48 fiber optic ribbon cable to a 200 μm 48 fiber optic cable using 6 fiber base ribbon units, in accordance with aspects of the present disclosure.

FIG. 5 is a cross sectional view comparison of a conventional 250 μm 72 fiber optic ribbon cable to a 200 μm 72 fiber optic cable using 6 fiber base ribbon units, in accordance with aspects of the present disclosure.

FIG. 6 is a cross sectional view comparison of a conventional 250 μm 96 fiber optic ribbon cable to a 200 μm 96 fiber optic cable using 6 fiber base ribbon units, in accordance with aspects of the present disclosure.

FIG. 7 is a cross sectional view comparison of a conventional 250 μm 144 fiber optic ribbon cable to a 200 μm 144 fiber optic cable using 6 fiber base ribbon units, in accordance with aspects of the present disclosure.

FIG. 8 is a cross sectional view comparison of a conventional 250 μm 216 fiber optic ribbon cable to a 200 μm 216 fiber optic cable using 6 fiber base ribbon units, in accordance with aspects of the present disclosure.

FIG. 9 is a cross sectional view comparison of a conventional 250 μm 288 fiber optic ribbon cable to a 200 μm 288 fiber optic cable using 6 fiber base ribbon units, in accordance with aspects of the present disclosure.

FIG. 10 is a cross sectional view comparison of a conventional 250 μm 432 fiber optic ribbon cable to a 200 μm 432 fiber optic cable using 6 fiber base ribbon units, in accordance with aspects of the present disclosure.

FIG. 11 is a cross sectional view comparison of a conventional 250 μm 576 fiber optic ribbon cable to a 200 μm 576 fiber optic cable using 6 fiber base ribbon units, in accordance with aspects of the present disclosure.

FIG. 12 is a cross sectional view comparison of a conventional 250 μm 864 fiber optic ribbon cable to a 200 μm 864 fiber optic cable using 6 fiber base ribbon units, in accordance with aspects of the present disclosure.

FIG. 13 is a cross sectional view comparison of a conventional 250 μm 12 fiber ribbon to a 200 μm 12 fiber ribbon as aligned for splicing, in accordance with aspects of the present disclosure.

FIG. 14 is a cross sectional view comparison of a conventional 250 μm 12 fiber ribbon to a 200 μm 12 fiber ribbon as aligned for splicing after fibers 6 and 7 of the 200 μm 12 fiber ribbon are separated, in accordance with aspects of the present disclosure.

FIG. 15 is a cross-sectional view and associated parameter chart for dimensions of a fiber ribbon handler, in accordance with aspects of the present disclosure.

FIGS. 16-20 illustrate a method for fiber identification, in accordance with aspects of the present invention.

FIG. 21 is a cross-sectional view of a 216 fiber stack organized for fiber identification, in accordance with aspects of the present invention.

### DETAILED DESCRIPTION

Referring to FIG. 1, an optical communication cable, shown as cable 10, is shown according to an exemplary embodiment. Cable 10 includes a cable body, shown as cable jacket 12, having an inner surface that defines an internal area or region within which the various cable components discussed below are located. Generally, a plurality of optical fibers 14 is included among the cable components, and the cable 10 provides structure and protection to a plurality of optical fibers 14 during and after installation (e.g., protection during handling, protection from elements, protection from vermin, etc.).

In accordance with aspects of the present disclosure as shown in FIG. 1, a first type of core element may be an optical transmission core element 16 that includes an optical fiber group 18 of optical fiber ribbons located within tubes, such as buffer tubes 20. A plurality of these optical transmission core elements 16 may be wound in a pattern or arrangement (e.g., a spiral pattern, a helical pattern, SZ pattern, etc.) around a central support member, shown as central strength member 22. Central strength member may be formed from a material such as glass-reinforced plastic or metal (e.g., steel). The central strength member 22 may be surrounded by upjacket 24 and a water-swellable tape 26, for example.

Together, the optical transmission core elements 16 and the central strength member 22 form the core 28 of cable 10. An enclosing element 30, such as a film binder, armor or armor tape, or a water-swellable tape, for example, may be provided to surround the core 28 between the core and the jacket 12. A ripcord 32 may be provided to, upon application of a sufficient outwardly directed pulling force, rip through at least a portion of one of the cable components, for example, the enclosing element 30 and/or the jacket 12 to provide access to the core 28. In addition to or in place of the ripcord 32, the jacket 12 may comprise separation features that facilitate access to the core 28. For example, a pair of diametrically opposed discontinuities may be co-extruded to extend along the length of the cable 10 to enable easy separation of the jacket along a centerline of the cable 10.

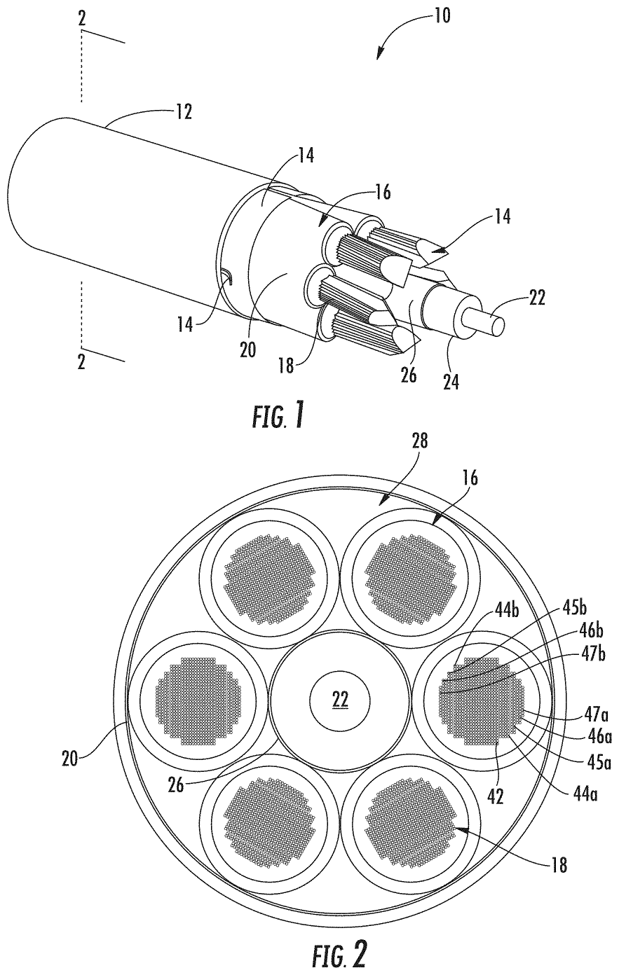

As shown in FIG. 2, each optical fiber group 18 may comprise any multiple of optical fiber subgroups 40, each optical fiber subgroup 40 having one set or multiple sets of 6 fiber base ribbons 42 arranged in substantially planar fashion. In accordance with aspects of the present disclosure, the 6 fiber base ribbons 42 are comprised of six 200 μm optical fibers, such as Corning® SMF-28® Ultra 200 fibers, encased in a conventional cured ribbon matrix to maximize per-cable/duct fiber capacity. Maintaining the more solid ribbon matrix in the 6 fibers ribbons of the present disclosure overcomes difficulties in handling and splicing experienced with the rollable ribbon type ribbons. In particular, mass fusion splicing of multiple 6 fiber 200 μm ribbons, for example, is easier and faster than similar mass fusing splicing of the flexible rollable ribbons and much easier and faster than field ribbonized loose fibers or single fiber mass fusion. In addition, the 200 μm fibers maintain the same 9.2 μm mode field diameter of conventional 250 μm fiber. Although referred to herein as 200 μm fiber, the actual spacing between fibers in a 6 fiber ribbon of 200 μm fibers may be closer to 208 μm when accounting for a coloring layer that may be applied to the individual fibers for identification.

Each optical fiber group 18 as such may then comprise any number of stacked optical fiber subgroups 40, wherein the optical fiber subgroups 40 are preferably of varying width to create a stepped perimeter of the optical fiber group 18. For example, optical fiber group 18 can include a medial subgroup 42 of optical fiber ribbons with at least one set of lateral subgroups 44a,44b on opposing sides thereof. Lateral subgroups 44a,44b can be immediately flanked by lateral subgroups 45a,45b; lateral subgroups 45a,45b can be immediately flanked by lateral subgroups 46a,46b; and lateral subgroups 46a, 46b can be flanked by lateral subgroups 47a, 47b. In a preferred exemplary embodiment, medial subgroup 42 may have twelve layers of 36 optical fiber ribbons, each layer having six 6-fiber subunits; lateral subgroups 44a,44b contain four layers each of 30 optical fiber ribbons, each 30 optical fiber ribbon layer having five 6-fiber subunits; lateral subgroups 45a,45b contain two layers each of 24 optical fiber ribbons, each 24 optical fiber ribbon layer having four 6-fiber subunits; lateral subgroups 46a,46b contain two layers each of 18 optical fiber ribbons, each 18 optical fiber ribbon layer having three 6-fiber subunits; and each lateral subgroups 47a,47b contain a single layer of a 12 optical fiber ribbon having two 6-fiber subunits. Accordingly, each optical fiber subgroup 18 may comprise, for example, 864 fibers. In accordance with aspects of the present disclosure as shown in FIGS. 1 and 2, an optical fiber cable 10 with six buffer tubes 20 comprises 5184 fibers and has a cable inside diameter of approximately 36 mm and a fiber density of approximately 4 fibers/mm².

In accordance with yet other aspects of the present invention, the central member unit (22, 24, 26) may be replaced with a seventh optical transmission core element 16 having an optical fiber group 18 of up to an additional 864 μm fibers. A cable with a seventh optical transmission core element 16 may have up to 6048 fibers in the same 36 mm cable diameter for a fiber density of approximately 4.7 fibers/mm².

The various subgroups above are based on providing cables or tube assemblies of maximum density with fiber counts above 4320 fibers that would fit into a two inch duct. However, the number of subgroups 40 and the number of fiber ribbons comprising a layer in each subgroup may vary depending on the size of the cable desired and the fiber density necessary to accommodate fiber demand for that particular cable size. Each subgroup may contain at least one respective layer having at least one optical fiber ribbon. Each subgroup can be progressively smaller, for example, starting at the medial subgroup and moving to the lateral subgroups. Optical fiber ribbon group 18 can therefore define a step-like profile that can be generally symmetrical about medial subgroup 42. The step-like profile can define a high fiber packing density by substantially filling up the volume of the core 28 with, for example, sets of optical fiber ribbons. In other words, the fiber packing density of cable 10 can be optimized by the step-like profile. The width w and/or height h can be constant from step to step, or they become progressively smaller or larger from step to step in the profile (FIG. 1).

Table 1 below provides a comparison of various size optical fiber ribbon groups 18 for cables or tube assemblies comprising 250 μm conventional 12 fiber ribbon stacks versus optical fiber ribbon groups 18 for cables or tube assemblies comprising 200 nm multistep 6 fiber base ribbon stacks.

| | | | | Circles with | f/mm² with |
|---|---|---|---|---|---|
| | | Circles with | f/mm² with | 200 μm | 200 μm |
| | | 250 μm | 250 μm | multistep 6f | multistep 6f |
| | Fiber | conventional | conventional | base ribbon | base ribbon |
| FIG. | Count | ribbon stack | ribbon stack | stack | stack |
| 3 | 24 | 3.1 | 2.5 | 1.5 | 10.7 |
| 4 | 48 | 3.3 | 4.4 | 2.4 | 8.3 |
| 5 | 72 | 3.4 | 6.2 | 2.7 | 9.9 |
| 6 | 96 | 3.8 | 6.6 | 2.9 | 11.4 |
| 7 | 144 | 4.7 | 6.5 | 3.9 | 9.5 |
| 8 | 216 | 6.1 | 5.8 | 4.3 | 11.7 |
| 9 | 288 | 7.1 | 5.7 | 5 | 11.5 |
| 10 | 432 | 8.1 | 6.6 | 5.7 | 13.3 |
| 11 | 576 | 9.7 | 6.1 | 6.7 | 12.8 |
| 12 | 864 | 11.5 | 6.5 | 7.7 | 14.6 |

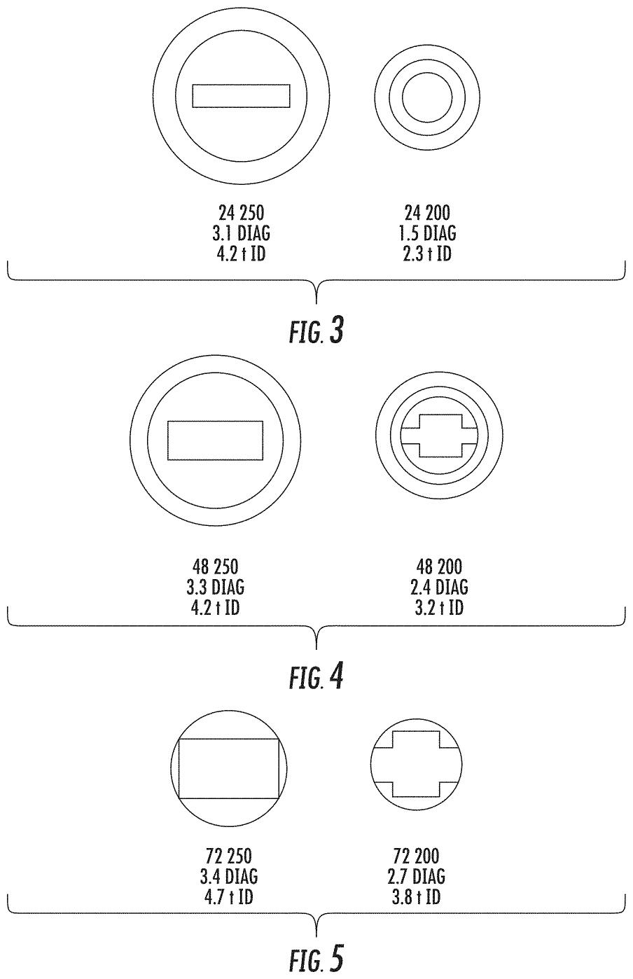

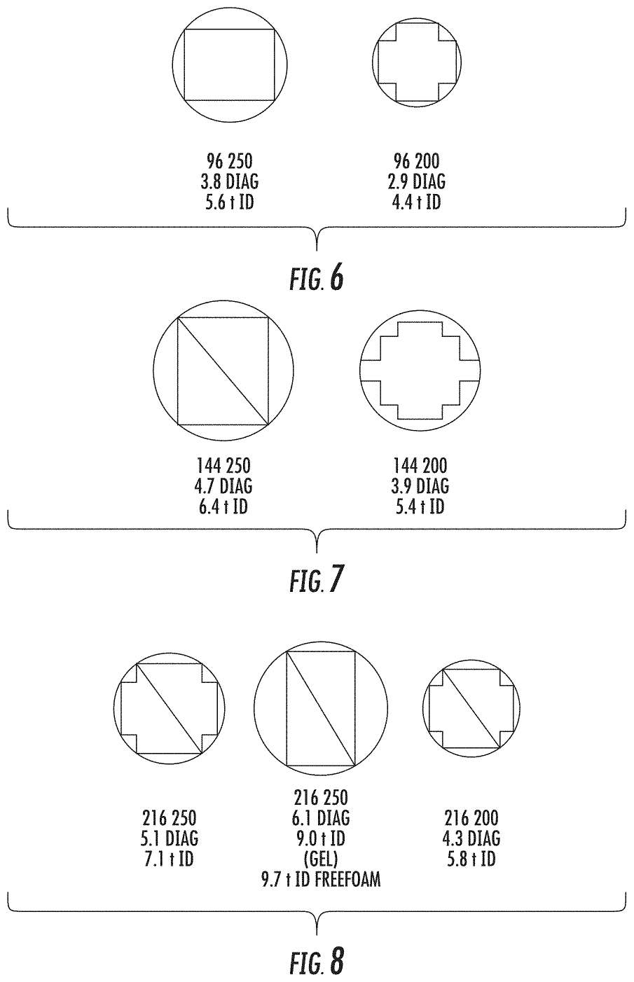

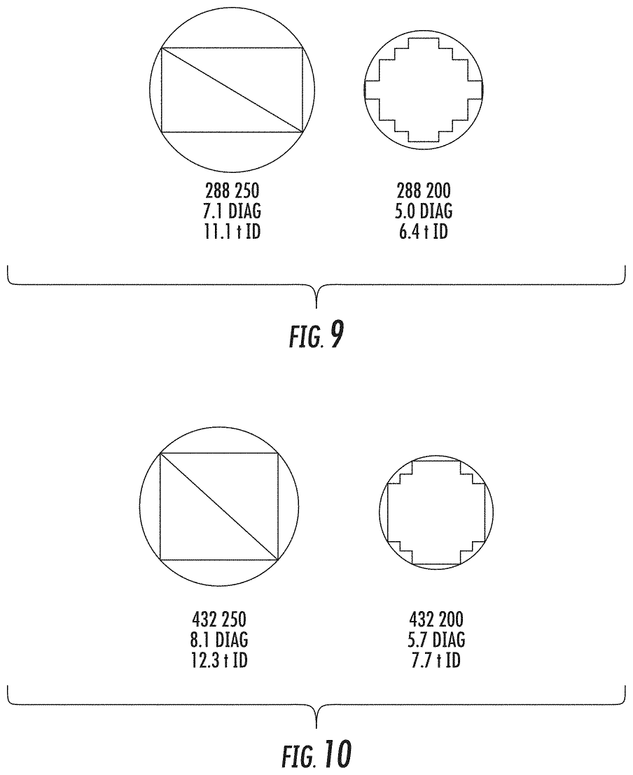

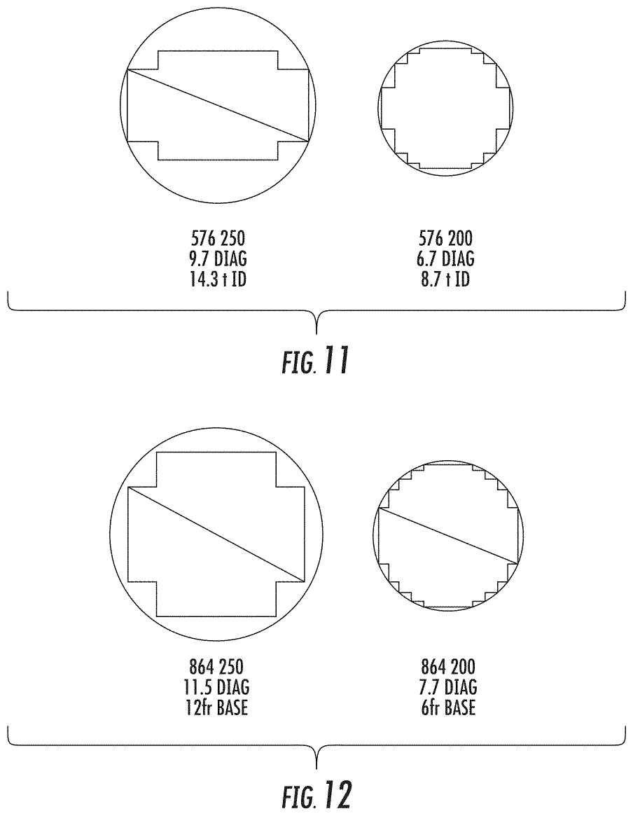

As can be seen from the chart and the associated figures, the inside diameters represented by the circles in the figures illustrates the ability to reduce cable diameters due to increased fiber densities capable when using 200 μm multistep 6 fiber base ribbon stacks. As shown in FIG. 3, for example, a conventional 250 μm 24 fiber count tube may have two 12 fiber ribbons stacked with a 3.1 mm diagonal dimension and a 4.2 mm tube inner diameter. The resulting fiber density is 2.5 fibers/mm². Compare this to the example shown in FIG. 4, wherein the same 24 fiber count tube having four 200 μm 6 fiber ribbons stacked has a 1.5 mm diagonal dimension for a tube having a 2.3 mm inner diameter. The resulting fiber density is 10.7 fiber/mm², which is a much better use of the space allowing for the smaller tube diameter. As shown in FIG. 5, for example, a conventional 250 μm 48 fiber count tube may have four 12 fiber ribbons stacked with a 3.3 mm diagonal dimension and a 4.2 mm tube inner diameter. The resulting fiber density is 4.4 fibers/mm². Compare this to the example shown in FIG. 6, wherein the same 48 fiber count tube has eight 200 μm 6 fiber ribbons stacked in tiered formation with a medial subgroup of two layers, each layer comprising two 6 fiber ribbons adjacent to form a 12 fiber wide layer, and two lateral subgroups on either side of the medial subgroup, each lateral subgroup having two layers of 6 fiber ribbons. This results in a 2.4 mm diagonal dimension of the ribbon stack in a tube having a 3.2 mm inner diameter. The resulting fiber density is 8.3 fiber/mm². Table 1 and FIGS. 3-12 outline all of the corresponding values for conventional fiber stack sizes, including the 864 fiber configuration of the cable shown in FIGS. 1 and 2, in which case the 200 μm 6 fiber ribbons stacked in tiered formation as shown have a 7.7 mm diagonal dimension that essentially corresponds to the inner diameter of the tube or cable. In this case, a maximize fiber density is realized at 14.6 fibers/mm².

In accordance with aspects of the present disclosure, the various configurations of 6 fiber base ribbon stacks may allow for ribbon cable fiber counts up to 6048 fibers installable in a 2 inch duct, ribbon cable fiber counts in a stranded buffer tube cable of up to 1728 installable in a 1.25 inch duct, and ribbon fiber counts in a standard single tube ribbon cable design of up to 864 fibers in a 1 inch duct. Specific stack configurations may be set for specific size cables in order to further enable the mass fusion splicing process. For example, the 144 fiber configuration has four six fiber layers, seven twelve fiber layers, and two 18 fiber layers. The configurations are specifically designed such that when ribbon layers of 6, 18 or 30 fibers are used, there is always an even number of the respective fiber layers of that count in the stack so that the trailing base 6 fiber ribbon of the first ribbon layer can be spliced alongside the leading base 6 fiber ribbon of the second ribbon layer for a twelve fiber mass splice. When the stack returns to a 12, 24, or 36 fiber ribbon dimension for each layer, then adjacent base 6 fiber ribbons for splicing may be pulled from the same ribbon layer.

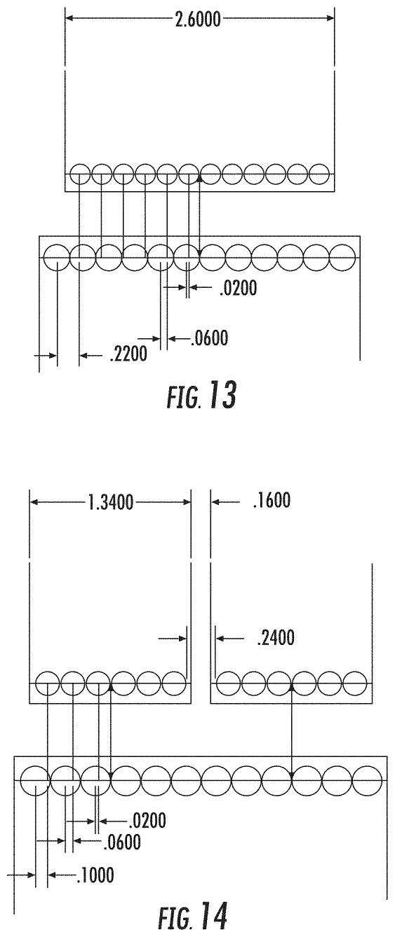

In accordance with aspects of the present disclosure, a method for mass fusion includes splitting the 12, 18, 24, 30 or 36 fiber layers into the individual 6 fiber base ribbons so that a gap between the 6 fiber base ribbons may be used to do a 12 fiber mass fusion splice. As shown in FIG. 13, when trying to mass fusion splice 12 200 μm fibers in ribbon form to 12 250 μm fibers in ribbon form, fibers 1 and 12 of each ribbon will be offset by 220 microns while fibers 6 and 7 of each ribbon are only offset by 20 microns. As shown in FIG. 14, to overcome the offsets shown in FIG. 13, 12 fiber 200 μm ribbons may be manufactured to have two six fiber subunits separated by a gap along at least a portion of the longitudinal center axis in order to define a preferential tear portion, as disclosed in U.S. Pat. Nos. 6,853,783 or 7,532,796, assigned to Corning Optical Communications, LLC of Hickory, N.C., the contents of each of which are hereby incorporated herein in their entireties. In this manner, the 12 fiber ribbons may be split into two six fiber base ribbons, thereby reducing the maximum offset. For example, as shown in FIG. 14, the maximum offset is now 100 microns at fibers 1 and 12 of each ribbon, which is within tolerance for mass fusion splicing yield and splice loss attenuation per fiber.

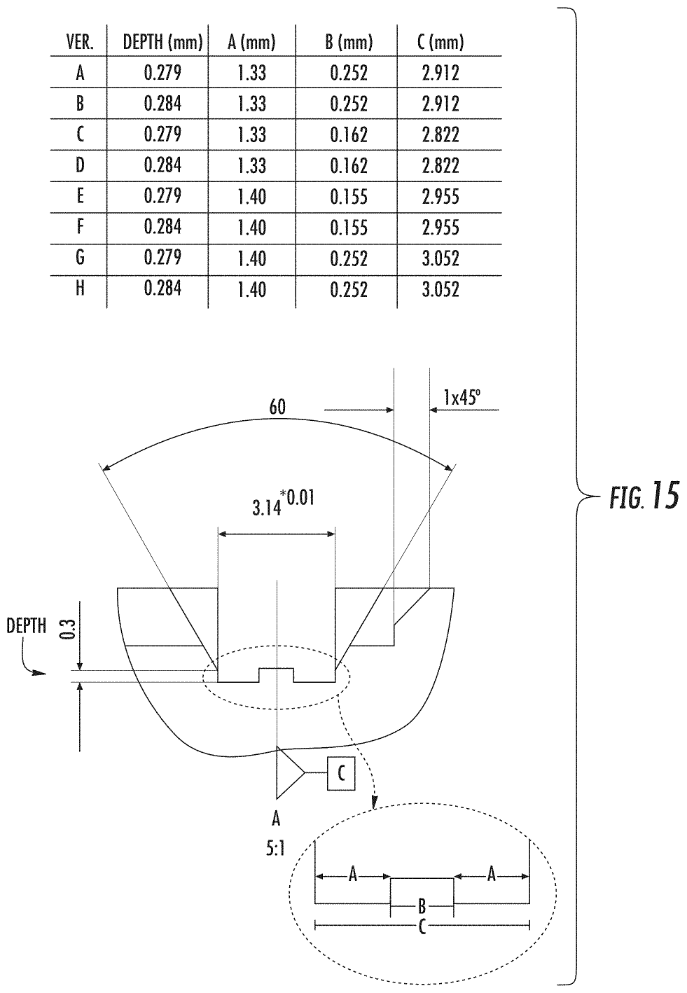

In accordance with yet other aspects of the present disclosure, and as shown in FIG. 15, a ribbon handler device that holds the ribbons for thermal stripping, cleaving and mass fusion splicing may be used to provide the necessary spacing for splicing. The handler device 100 may include a rib 110 that protrudes from the channel 112 used to hold a conventional 12 fiber 250 um ribbon. By varying the depth of the rib 110 and the spacing dimensions A and C, as illustrated in the table of FIG. 15, up to 240 microns of space may be inserted between fibers 6 and 7 of the mass fusion splice. The offset between fibers 1, 6, 7 and 12 will now be 100 microns and all fibers will be able to fit and work inside the 250 um spaced V-grooves of conventional mass fusion splicers.

To achieve attenuation performance, aspects of the present disclosure may include cables with high performing 200 um fibers, such as fibers with improved microbend performance as disclosed in U.S. Patent Application Ser. No. 62/341,369, which is incorporated herein.

To identify the 6 fiber ribbons during splicing, a novel identification method is disclosed. As shown in FIG. 16, schematics of two 18 fiber ribbons, Ribbon 1 and Ribbon 2, are printed as ribbon 5 and 6, and ribbon 6 and 7. The 18 fiber Ribbon 1 printed as ribbon 5 and 6 has the last 6 fibers colored RD-AQ (the first 12 fibers are BL-AQ and remain as ribbon 5). The 18 fiber Ribbon 2 printed as ribbon 6 and 7 has the first 6 fibers colored BL-WH (the last 12 are BL-AQ and remain as ribbon 7).

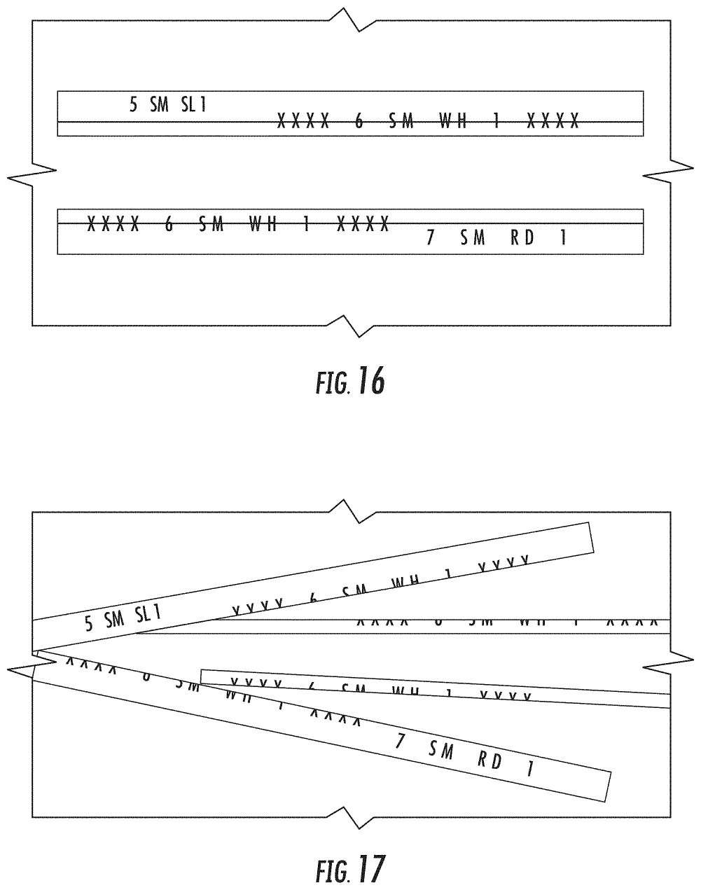

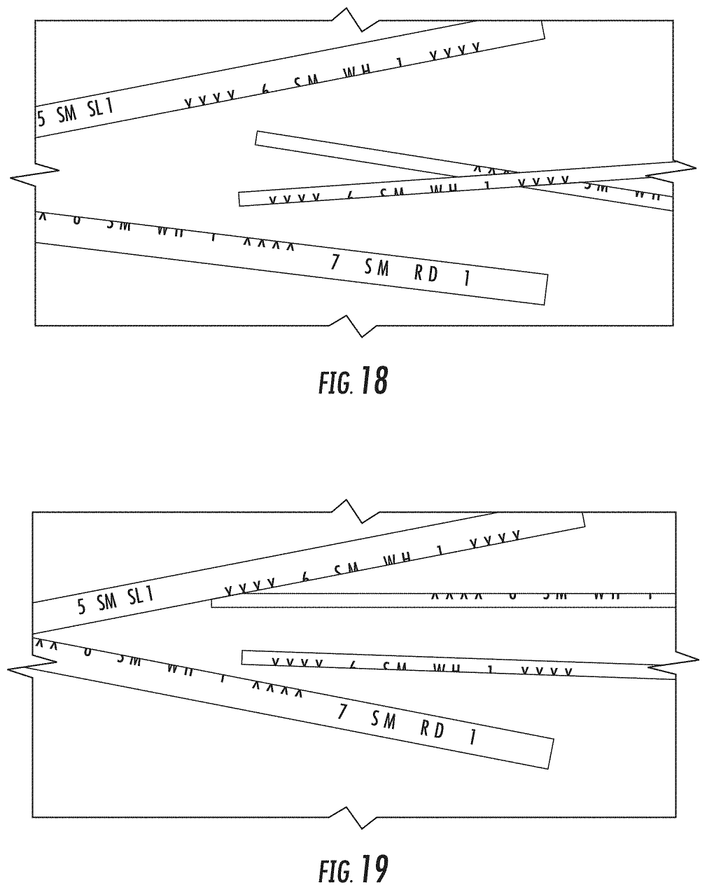

As shown in FIG. 17, during splicing the two 6 fiber ribbons of ribbon 6 are split from 18 fiber Ribbon 1 and 18 fiber Ribbon 2. As shown in FIG. 18, the BL-WH of 18 fiber Ribbon 1's ribbon 6 is aligned with the RD-AQ of 18 fiber Ribbon 2's ribbon six. As shown in FIG. 19, the BL-WH may be moved to top and the RD-AQ to bottom so the result is as shown in FIG. 20. By aligning the X's, the print for ribbon 6 (e.g., 6 SM WH 1) may still be read. In particular with 864 ribbon stacks, this type of identification method may be beneficial to track the seventy-two 12 fiber ribbon units in the stack.

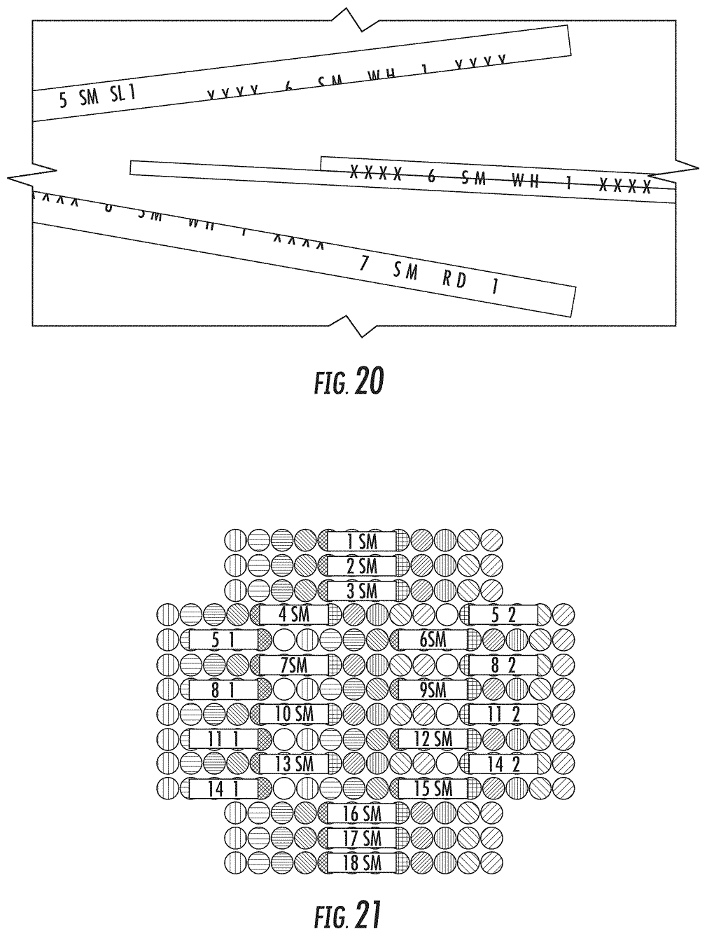

FIG. 21 shows a schematic cross-section of a 216 fiber ribbon stack with RD-AQ of ribbon 5 at the end of ribbon 4, and BL-AQ of ribbon 5 at the beginning of ribbon 6. By assigning particular color sequences in this manner, identification may be simplified and set to ease mass fusion splicing in the field. For example, as shown in FIG. 21, one of the ribbon stack will continue to start with all BL fibers, and the opposite side of the stack will continue to end with all AQ fibers while there are ribbons (18 fiber, 30 fiber) that are not divisible by 12. Other color sequences may include all of the extra 6 fiber base subunits in the 18 fiber and 30 fiber ribbon layers all on the left side, for example, or all on the right side of the stack.

The present inventions have thus been described with reference to the exemplary embodiments, which embodiments are intended to be illustrative of inventive concepts rather than limiting. Persons of ordinary skill in the art will appreciate that variations and modifications of the foregoing embodiments may be made without departing from the scope of the appended claims. The step-like profile can include the interposition of a subgroup having a larger or smaller fiber count than neighboring subgroups. Each ribbon/subunit in a subgroup can be marked for ease of identification even in the event the subgroup shifts during cable bending. Further, the optical fiber subgroups can respectively include generally unequal optical fiber counts (not shown). Optical fibers that are less bend-sensitive can be placed in predefined locations in a group/subgroup/ribbon for maintaining a low overall attenuation of the fiber optic cable.

What is claimed is:

1. A fiber optic cable comprising:
a cable jacket having an inner surface that defines a core; and
an optical transmission core element that comprises:
at least one buffer tube; and
an optical fiber group having a plurality of optical fiber ribbons located within the buffer tube, wherein the optical fiber group comprises a plurality of optical fiber subgroups, each subgroup having one or more 6 fiber base ribbon subunits arranged in substantially planar fashion, each 6 fiber base ribbon subunit comprising 200 μm optical fibers in a cured ribbon matrix.

2. The fiber optic cable of claim 1, wherein each 200 μm optical fiber has a 9.2 μm mode field diameter.

3. The fiber optic cable of claim 1, wherein the plurality of subgroups have varying widths to create a stepped perimeter of the optical fiber group.

4. The fiber optic cable of claim 3, wherein the plurality of subgroups includes a medial subgroup and a first set of lateral subgroups on opposing sides of the medial subgroup.

5. The fiber optic cable of claim 4, wherein the medial subgroup includes twelve layers of optical fiber ribbons, each layer having six 6 fiber base ribbon subunits.

6. The fiber optic cable of claim 5, wherein each subgroup of the first set of lateral subgroups has four layers of optical fiber ribbons, each layer having five 6 fiber base ribbon subunits.

7. The fiber optic cable of claim 6, further comprising a second set of lateral subgroups, a third set of lateral subgroups, and a fourth set of lateral subgroups.

8. The fiber optic cable of claim 7, wherein each subgroup of the second set of lateral subgroups has two layers of optical fiber ribbons, each layer having four 6 fiber base ribbon subunits.

9. The fiber optic cable of claim 8, wherein each subgroup of the third set of lateral subgroups has two layers of optical fiber ribbons, each layer having three 6 fiber base ribbon subunits.

10. The fiber optic cable of claim 9, wherein each subgroup of the fourth set of lateral subgroups has a single layer of optical fiber ribbons, each single layer having two 6 fiber base ribbon subunits.

11. The fiber optic cable of claim 10, wherein the at least one buffer tube includes a total of six buffer tubes.

12. The fiber optic cable of claim 11, wherein an inside diameter of the fiber optic cable is 36 millimeters such that a fiber density is approximately 4 fibers/mm².

13. The fiber optic cable of claim 11, further comprising a central strength member.

14. The fiber optic cable of claim 10, wherein the at least one buffer tube includes a total of seven buffer tubes, and wherein one of the buffer tubes is arranged as a central core member and the other six buffer tubes are arranged to surround the central core member.

15. The fiber optic cable of claim 14, wherein an inside diameter of the fiber optic cable is 36 millimeters such that a fiber density is approximately 4.7 fibers/mm².

16. The fiber optic cable of claim 4, wherein the medial subgroup includes two layers of optical fiber ribbons, each layer having two 6 fiber base ribbon subunits.

17. The fiber optic cable of claim 16, wherein each subgroup of the first set of lateral subgroups has two layers of optical fiber ribbons, each layer having two 6 fiber base ribbon subunits.

18. The fiber optic cable of claim 17, wherein an inside diameter of the fiber optic cable is 3.2 millimeters such that a fiber density is approximately 8.3 fibers/mm².

19. The fiber optic cable of claim 1, wherein each optical fiber ribbon of the plurality of optical fiber ribbons includes two 6 fiber base ribbon subunits separated by a gap along at least a portion of a longitudinal center axis of the optical fiber ribbon, the gap defining a preferential tear feature.

20. The fiber optic cable of claim 1, further comprising an enclosing element surrounding the optical transmission core element.
